(19) United States
(12) Patent Application Publication
(10) Pub. No.: US 2005/0055301 A1
(43) Pub. Date: Mar. 10, 2005

(54) Systems and methods for computing performance parameters of securities portfolios

(76) Inventors: Randolph B. Cohen, Cambridge, MA (US); Joshua D. Coval, Cambridge, MA (US); Lubos Pastor, Chicago, IL (US)

Correspondence Address: FOLEY HOAG, LLP;PATENT GROUP, WORLD TRADE CENTER WEST, 155 SEAPORT BLVD, BOSTON, MA, 02110, US

(21) Appl. No.: 10/716,391

(22) Filed: Nov. 17, 2003

Related U.S. Application Data
(60) Provisional application No. 60/443,445, filed on Jan. 29, 2003.

(51) Int. Cl. G06F 17/60

(52) U.S. Cl. 705/36

(57) ABSTRACT

Systems and methods for computing performance parameters of securities portfolios are described. In one embodiment, a method of computing a performance parameter of a first portfolio includes providing baseline portfolios, computing a financial return measure for each of the portfolios, computing a quality measure for each different security included in the portfolios, and computing the performance parameter for the first portfolio based on the quality measures and the relative weights of the securities included in the first portfolio. The securities can include one or more of a bond, a currency, a commodity, a futures contract, an option contract, and a stock, and the portfolios can include mutual funds.

### CLAIM OF PRIORITY

This application claims priority to U.S. Provisional Patent Application Ser. No. 60/443,445 filed on Jan. 29, 2003, the contents of which application are expressly incorporated by reference herein in their entirety.

### BACKGROUND

A securities portfolio includes holdings of one or more types of securities, such as bonds, commodities, currencies, futures contracts, option contracts, and stocks. A performance parameter is a parameter that can be used to assess the financial success of a portfolio with respect to one or more other portfolios. A mutual fund is a type of portfolio that includes diversified holdings in securities, e.g., holdings in different securities of a single type and/or holdings in securities of different types.

A variety of performance parameters are currently available for judging the financial success of mutual funds. Some of these performance parameters are based solely on financial returns, such as Jensen's alpha and Sharpe's ratio. Other performance parameters are based solely on the holdings of the mutual fund being assessd. Such performance parameters do not consider relationships between the holdings of different mutual funds, thereby inhibiting their reliability and utility.

### SUMMARY

Systems and methods for computing performance parameters of securities portfolios are described.

In one embodiment, a method of computing a performance parameter of a first portfolio includes providing baseline portfolios, computing a financial return measure for each of the portfolios, computing a quality measure for each different security included in the portfolios, and computing the performance parameter for the first portfolio based on the quality measures and the relative weights of the securities included in the first portfolio. The securities can include one or more of a bond, a currency, a commodity, a futures contract, an option contract, and a stock, and the portfolios can include mutual funds.

The financial return measure for a portfolio can be computed based on regressing financial returns for the portfolio in excess of a risk-free rate on a benchmark associated with an asset pricing model. The financial return measure can include one of a Jensen's alpha, a Capital Asset Pricing Model alpha, a Fama-French alpha, and a four-factor alpha.

The quality measure for a security can be computed based on the relative weights of the security in the portfolios and the financial return measures of the portfolios. The quality measure for the security can be computed based on, for each portfolio that includes the security, the product of the financial return measure for the portfolio and the relative weight of the security in the portfolio.

The performance parameter for the first portfolio can be computed based on, for each security included in the first portfolio, the product of the quality measure for the security and the relative weight of the security in the portfolio.

In one embodiment, the method can further include iteratively computing the performance parameter for the first portfolio. The performance parameter can be iteratively computed based on computing a performance parameter for each of the baseline portfolios, using the computed performance parameters as the financial return measures, and re-computing the performance parameter for the first portfolio.

In one embodiment, a method for computing a performance parameter of a first portfolio includes providing baseline portfolios, computing a financial return measure for each of the portfolios, and computing the performance parameter for the first portfolio based on the financial return measures of the portfolios and the degrees of similarity in securities holdings between the first portfolio and each of the baseline portfolios.

The performance parameter of the first portfolio can be computed based on a weighted average of the financial return measures of the portfolios, where the weight of a financial return measure of a portfolio in the weighted average is based on a degree of similarity in securities holdings between the portfolio and the first portfolio.

The degree of similarity in securities holdings between a portfolio and the first portfolio can be based on, for each security included in one or more of the portfolio and the first portfolio, a product of the relative weight of the security in the portfolio and the relative weight of the security in the first portfolio.

In one embodiment, a method of computing a performance parameter of a first portfolio includes providing baseline portfolios, computing a financial return measure for each of the portfolios, computing a quality measure for each security purchased or sold in the first portfolio during a time period, and computing the performance parameter for the first portfolio based on the quality measures and the changes in the relative weights for each security purchased or sold in the first portfolio during the time period.

The quality measure for a security can be computed based on the fraction of all purchases of the security during the time period accounted for by each portfolio, the fraction of all sales of the security during the time period accounted for by each portfolio, and the financial return measure of each portfolio.

The performance parameter for the first portfolio can be computed based on, for each security purchased in the first portfolio, a first product of the fraction of all purchases in the first portfolio accounted for by the security and the quality measure of the security and, for each security sold in the first portfolio, a second product of the fraction of all sales in the first portfolio accounted for by the security and the quality measure of the security.

In one embodiment, a method of computing a performance parameter of a first portfolio includes providing baseline portfolios, computing a financial return measure for each of the portfolios, and computing the performance parameter for the first portfolio based on the financial return measures for each of the portfolios and the degrees of similarity in changes in securities holdings during a time period between the first portfolio and each of the baseline portfolio.

The performance parameter for the first portfolio can be computed based on a pseudo-weighted average of the financial return measures of the portfolios, where the weight of a financial return measure of a portfolio in the pseudo-weighted average is based on a degree of similarity in changes in securities holdings during the time period between the portfolio and the first portfolio, and where the sum of the weights in the pseudo-weighted average is zero.

The degree of similarity in changes in securities holdings between a portfolio and the first portfolio can be based on, for each security purchased during the time period, the fraction of all purchases of the security accounted for by each portfolio and the fraction of all purchases in the first portfolio accounted for by the security and, for each security sold during the time period, the fraction of all sales of the security accounted for by each portfolio and the fraction of all sales in the first portfolio accounted for by the security.

Processor programs for computing performance parameters for portfolios are described. The processor programs can be stored on processor-readable mediums and, in embodiments, can include instructions to cause a processor to execute the previously described methods.

These and other features of the systems and methods described herein can be more fully understood by referring to the following detailed description and accompanying drawings.

### BRIEF DESCRIPTION OF THE DRAWINGS

FIG. 1 schematically illustrates an exemplary system for computing a performance parameter of a securities portfolio.

FIG. 2 schematically illustrates exemplary securities portfolios.

FIG. 3 schematically illustrates embodiments of methods for computing a holdings performance-parameter for a securities portfolio.

FIGS. 4A and 4B schematically illustrate embodiments of methods for computing a changes-in-holdings performance- parameter for a securities portfolio.

### DETAILED DESCRIPTION

Illustrative embodiments will now be described to provide an overall understanding of the disclosed systems and methods. One or more examples of the illustrative embodiments are shown in the drawings. Those of ordinary skill in the art will understand that the disclosed systems and methods can be adapted and modified to provide systems and methods for other applications, and that other additions and modifications can be made to the disclosed systems and methods without departing from the scope of the present disclosure. For example, features of the illustrative embodiments can be combined, separated, interchanged, and/or rearranged to generate other embodiments. Such modifications and variations are intended to be included within the scope of the present disclosure.

The disclosed systems and methods relate to computing performance parameters of securities portfolios. As previously described, a securities portfolio (hereinafter referred to as a “portfolio”) includes holdings of one or more types of securities, and a performance parameter is a parameter that can be used to assess the financial success of a portfolio with respect to one or more other portfolios. Generally, the disclosed systems and methods can compute a holdings performance-parameter (“holdings parameter”) and a changes-in-holdings performance-parameter (“changes parameter”) for a portfolio based on relationships between the holdings of the portfolio and the holdings of other portfolios referred to as baseline portfolios. The disclosed systems and methods compute the holdings parameter for a portfolio based on a degree of similarity in holdings at a time between the portfolio and one or more baseline portfolios and the changes parameter based on a degree of similarity in changes in holdings during a time period between the portfolio and one or more baseline portfolios. The holdings and changes parameters can be used to assess the relative financial success of a portfolio.

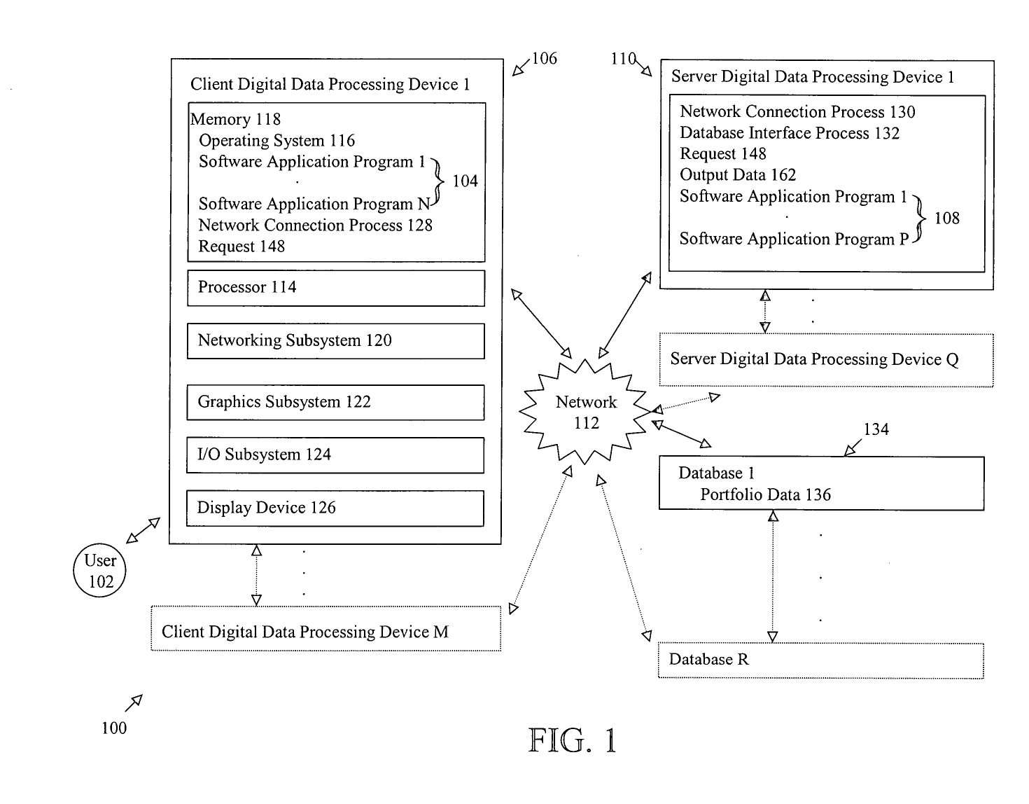

FIG. 1 schematically illustrates an exemplary system for computing a performance parameter of a portfolio. As shown in FIG. 1, the illustrated system 100 can include one or more client digital data processing devices 106 (“client”), one or more server digital data processing devices 110 (“server”), and one or more databases 134. The client 106, the server 110, and the database 134 can communicate using one or more data communications networks 112. The features in a digital data processing device are shown as residing in the client 106. Those of ordinary skill in the art will understand that one or more of the features of the client 106 can be present in the server 110.

As shown in the system 100 of FIG. 1, a user 102 desiring to compute a performance parameter of a portfolio can execute one or more software application programs 104 (such as, for example, an Internet browser and/or another type of application program capable of providing an interface to a performance-parameter computation program) residing on the client 106 to generate data messages that are routed to, and/or receive data messages generated by, one or more software application programs 108 (e.g., performance-parameter computation programs) residing on the server 110 via the data communications network 112. A data message can comprise one or more data packets, and the data packets can comprise control information (e.g., addresses of the clients and the servers 106, 110, names/identifiers of the software application programs 104, 108, etc.) and payload data (e.g., data relevant to computing a performance parameter, such as a request to compute a performance parameter 148 and output data 162 including a computed performance parameter for the portfolio).

The software application programs 104 can include one or more software processes (e.g., a calculation process/engine) executing within one or more memories 118 of the client 106. Similarly, the software application programs 108 can include one or more software processes executing within one or more memories of the server 110. The software application programs 108 can include one or more sets of instructions and/or other features that can enable the server 110 to compute a performance parameter. As described herein, the software application program 108 can include instructions for processing portfolio data 136 to generate output data 162. The software application programs 104, 108 can be provided using a combination of built-in features of one or more commercially available software application programs and/or in combination with one or more custom-designed software modules. Although the features and/or operations of the software application programs 104, 108 are described herein as being executed in a distributed fashion (e.g., operations performed on the networked client and servers 106, 110), those of ordinary skill in the art will understand that at least some of the operations of the software application programs 104, 108 can be executed within one or more digital data processing devices that can be connected by a desired digital data path (e.g. point-to-point, networked, data bus, etc.).

The digital data processing device 106, 110 can be a personal computer, a computer workstation (e.g., Sun, Hewlett-Packard), a laptop computer, a server computer, a mainframe computer, a handheld device (e.g., a personal digital assistant, a Pocket Personal Computer (PC), a cellular telephone, etc.), an information appliance, and/or another type of generic or special-purpose, processor-controlled device capable of receiving, processing, and/or transmitting digital data. A processor 114 refers to the logic circuitry that responds to and processes instructions that drive digital data processing devices and can include, without limitation, a central processing unit, an arithmetic logic unit, an application specific integrated circuit, a task engine, and/or combinations, arrangements, or multiples thereof.

The instructions executed by a processor 114 represent, at a low level, a sequence of “0's” and “1's” that describe one or more physical operations of a digital data processing device. These instructions can be pre-loaded into a programmable memory (e.g., an electrically erasable programmable read-only memory (EEPROM)) that is accessible to the processor 114 and/or can be dynamically loaded into/from one or more volatile (e.g., a random-access memory (RAM), a cache, etc.) and/or non-volatile (e.g., a hard drive, etc.) memory elements communicatively coupled to the processor 114. The instructions can, for example, correspond to the initialization of hardware within the digital data processing devices 106, 110, an operating system 116 that enables the hardware elements to communicate under software control and enables other computer programs to communicate, and/or software application programs 104, 108 that are designed to perform operations for other computer programs, such as operations relating to computing performance parameters. The operating system 116 can support single-threading and/or multi-threading, where a thread refers to an independent stream of execution running in a multi-tasking environment. A single-threaded system is capable of executing one thread at a time, while a multi-threaded system is capable of supporting multiple concurrently executing threads and can perform multiple tasks simultaneously.

A local user 102 can interact with the client 106 by, for example, viewing a command line, using a graphical and/or other user interface, and entering commands via an input device, such as a mouse, a keyboard, a touch sensitive screen, a track ball, a keypad, etc. The user interface can be generated by a graphics subsystem 122 of the client 106, which renders the interface into an on- or off-screen surface (e.g., on a display device 126 and/or in a video memory). Inputs from the user 102 can be received via an input/output (I/O) subsystem 124 and routed to a processor 114 via an internal bus (e.g., system bus) for execution under the control of the operating system 116.

Similarly, a remote user (not shown) can interact with the digital data processing devices 106, 110 over the data communications network 112. The inputs from the remote user can be received and processed in whole or in part by a remote digital data processing device collocated with the remote user. Alternatively and/or in combination, the inputs can be transmitted back to and processed by the local client 106 or to another digital data processing device via one or more networks using, for example, thin client technology. The user interface of the local client 106 can also be reproduced, in whole or in part, at the remote digital data processing device collocated with the remote user by transmitting graphics information to the remote device and instructing the graphics subsystem of the remote device to render and display at least part of the interface to the remote user. Network communications between two or more digital data processing devices can include a networking subsystem 120 (e.g., a network interface card) to establish the communications link between the devices. The communications link interconnecting the digital data processing devices can include elements of a data communications network, a point to point connection, a bus, and/or another type of digital data path capable of conveying processor-readable data.

In one illustrative operation, the processor 114 of the client 106 can execute instructions associated with the software application program 104 (including, for example, runtime instructions specified, at least partially, by the local user 102 and/or by another software application program, such as a batch-type program) that can instruct the processor 114 to at least partially control the operation of the graphics subsystem 122 in rendering and displaying a graphical user interface (including, for example, one or more menus, windows, and/or other visual objects) on the display device 126.

The data communications network 112 can include a series of network nodes (e.g., the client and the servers 106, 110) that can be interconnected by network devices and wired and/or wireless communication lines (e.g., public carrier lines, private lines, satellite lines, etc.) that enable the network nodes to communicate. The transfer of data (e.g., messages) between network nodes can be facilitated by network devices, such as routers, switches, multiplexers, bridges, gateways, etc., that can manipulate and/or route data from an originating node to a server node regardless of dissimilarities in the network topology (e.g., bus, star, token ring), spatial distance (e.g., local, metropolitan, wide area network), transmission technology (e.g., transfer control protocol/internet protocol (TCP/IP), Systems Network Architecture), data type (e.g., data, voice, video, multimedia), nature of connection (e.g., switched, non-switched, dial-up, dedicated, or virtual), and/or physical link (e.g., optical fiber, coaxial cable, twisted pair, wireless, etc.) between the originating and server network nodes.

FIG. 1 shows processes 128, 130, 132. A process refers to the execution of instructions that interact with operating parameters, message data/parameters, network connection parameters/data, variables, constants, software libraries, and/or other elements within an execution environment in a memory of a digital data processing device that causes a processor to control the operations of the digital data processing device in accordance with the desired features and/or operations of an operating system, a software application program, and/or another type of generic or specific-purpose application program (or subparts thereof). For example, a network connection process 128, 130 refers to a set of instructions and/or other elements that enable the digital data processing devices 106, 110, respectively, to establish a communication link and communicate with other digital data processing devices during one or more sessions. A session refers to a series of transactions communicated between two network nodes during the span of a single network connection, where the session begins when the network connection is established and terminates when the connection is ended. A database interface process 132 refers to a set of instructions and other elements that enable the server 110 to access the database 134 and/or other types of data repositories to obtain access to, for example, portfolio data 136. The accessed information can be provided to the software application program 108 for further processing and manipulation. Those of ordinary skill in the art will understand that the illustrated processes and/or their features can be combined into one or more processes. The illustrated processes 128, 130, 132 can also be provided using a combination of built-in features of one or more commercially-available software application programs and/or in combination with one or more custom-designed software modules.

The databases 134 can be stored on a non-volatile storage medium or a device known to those of ordinary skill in the art (e.g., compact disk (CD), digital video disk (DVD), magnetic disk, internal hard drive, external hard drive, random access memory (RAM), redundant array of independent disks (RAID), or removable memory device). As shown in FIG. 1, the databases 134 can be located remotely from the client 106. In some embodiments, the databases 134 can be located locally to the client 106 and/or can be integrated into the client 106. The databases 134 can include distributed databases. The databases 134 can include different types of data content and/or different formats for stored data content.

Portfolio data 136 includes data based on one or more portfolios and one or more securities included in the one or more portfolios. For example, portfolio data 136 includes data based on financial returns of one or more portfolios at one or more times (e.g., annual returns, quarterly returns, etc.) and data based on securities holdings of the one or more portfolios at one or more times (e.g., names and amounts of securities held at one or more times and financial returns of those securities at one or more times). Alternatively and/or in combination, in some embodiments, portfolio data 136 can include data based on changes in securities holdings of the one or more portfolios at one or more times (e.g., names and amounts of securities purchased and/or sold at one or more times). In embodiments, the times can include times that occurred prior to a time of a request 148 for computing a performance parameter of a portfolio. For example, the times can include times that occurred years, months, days, hours, minutes, and/or seconds prior to a time of a request 148.

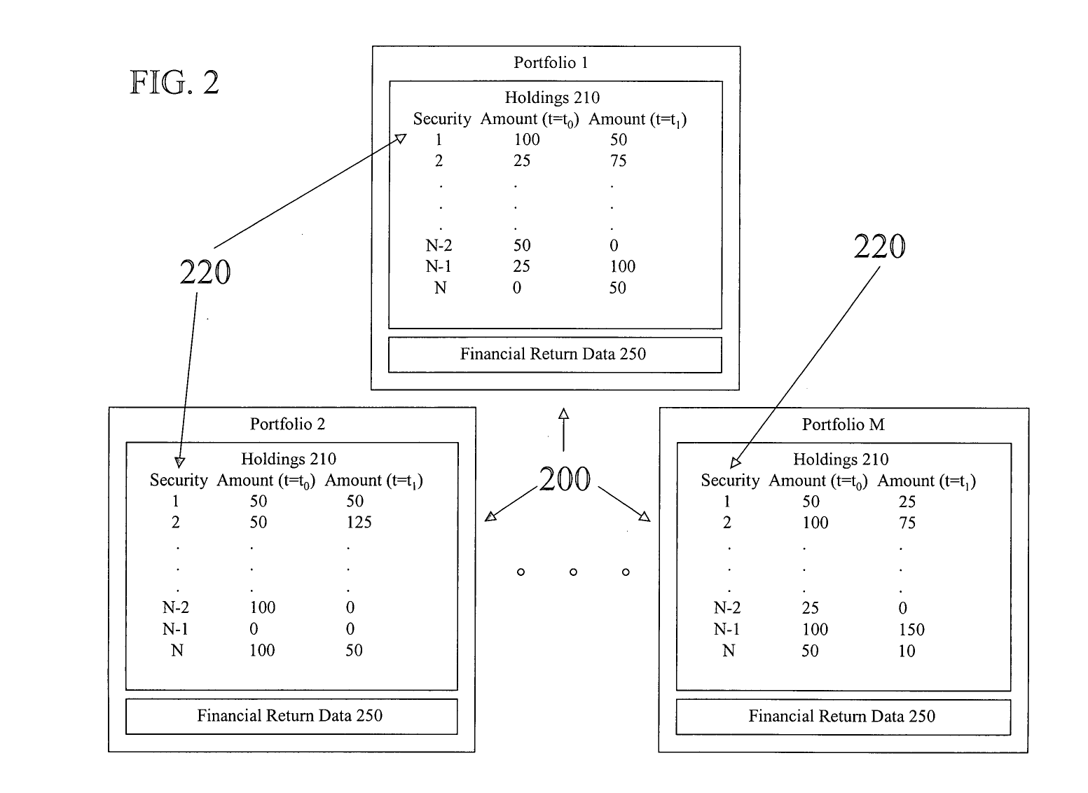

FIG. 2 shows exemplary portfolios that can be included in portfolio data 136. As will be understood by those of ordinary skill in the art, the exemplary portfolios should be interpreted in an illustrative manner, and the disclosed systems and methods can be implemented with portfolios that include features that are different than those shown in FIG. 2. The exemplary portfolios 200 can include tables and other types of data structures. As shown in FIG. 2, each of the portfolios 200 includes a holdings portion 210 including data based on the securities held by the portfolio at one or more times, such as the names and the amounts of the securities held at times to and t₁, and a financial return portion 250 having data based on financial returns of the portfolio at one or more times, such as the times t₀ and t₁ and other times. For reference, each of the exemplary portfolios 200 is associated with an index m=1, 2, . . . , M, and each different security 220 held by at least one of the M exemplary portfolios 200 at one or more of times (e.g., one or more of the times t₀ and t₁) is associated with an index n=1, 2, . . . , N. In one embodiment, the portfolios 200 can represent mutual funds traded on a financial market, such as the New York Stock Exchange, and the securities 220 can represent stocks and other securities held by the mutual funds. Data based on the mutual funds and the stocks held by the mutual funds (e.g., stock holdings of the mutual funds at one or more times, financial returns of the mutual funds at one or more times, financial returns of the stocks held by the mutual funds at one or more times, etc.) can be collected from a variety of sources known to those of ordinary skill in the art, such as, but not limited to, the U.S. Securities and Exchange Commission and the Center for Research in Security Prices.

Generally, the disclosed systems and methods compute holdings and changes parameters for a portfolio based on relationships in holdings between the portfolio and one or more other portfolios referred to as baseline portfolios. For example, as described herein, the disclosed systems and methods can compute holdings and changes parameters for the m=1 portfolio based on relationships in holdings between the m=1 portfolio and the remaining (e.g., baseline) M-1 portfolios in portfolio data 136. To improve the reliability of a computed performance parameter, the number of baseline portfolios (i.e., the number M-1) should be at least 10, and preferably, at least 100.

In one illustrative operation and with reference to FIG. 1, the software application program executing within the memory 118 of the client 106 can detect a request 148 to compute a performance parameter of a portfolio from the user 102 by, for example, receiving an indication of such selection from the I/O subsystem 124 that detected a mouse click, a keyboard entry, and/or another input event initiated by the user 102. In response to the user selection of a request 148, the software application program 104 can access a set of portfolios (e.g., the M portfolios or mutual funds in FIG. 2) supported by the software application program 104 and can instruct the graphics subsystem 122 (via the processor 114) to display the supported portfolios in a graphical user interface (e.g. via a pull-down menu). The user 102 can then initiate another input event corresponding to a selection of a portfolio from a set of supported portfolios (e.g., a selection of portfolio m=1 from the M portfolios in FIG. 2). The software application program 104 can detect the user's selection of the portfolio and can display the different available parameter types, i.e., holdings and changes types of parameters, within a hierarchical tree in the graphical user interface, for example. Similar sequences of input events and detections by the software application program 104 can enable the user 102 to specify one or more additional parameters that define a request of interest, such as a time (which refers to computing the holdings performance parameter for a selected portfolio based on holdings at the selected time, e.g., the time t₁ in FIG. 2,) or a time period (which refers to computing the changes performance parameter for a selected portfolio based on changes in holdings during the selected time period, e.g., the time period t₀-t₁ in FIG. 2). The request 148 and its associated portfolio, parameter type, and time or time period selected by the user 102 can be maintained in the memory 118 of the client 106 prior to transmission to the server 110 via the network 112. The software application program 104 can apply one or more rules to the request 148 to reduce the occurrence of erroneous requests. One or more of these rules can be contained in memory 118. Alternatively and/or in combination, the software application program 104 can access one or more of these rules from the database 134 via the network 112. As will be understood by those of ordinary skill in the art, in one embodiment, the software application program 104 can apply one or more data validation rules to the request 148 to determine the validity of the parameters associated with the request 148 and notify the user 102 of errors.

With continuing reference to FIG. 1, the software application program 104 can instruct the network connection process 128 of the client 106 to transmit the parameters associated with the request 148 selected by the user 102 to a calculation process or another software process associated with the software application program 108 executing on the server 110 by, for example, encoding, encrypting, and/or compressing the selected request 148 into a stream of data packets that can be transmitted between the networking subsystems 120 of the digital data processing devices 106, 110. The network connection process 130 executing on the server 110 can receive, decompress, decrypt, and/or decode the information contained in the data packets and can store such elements in a memory accessible to the software application program 108. The software application program 108 can process the request 148 by identifying the parameter type and portfolio associated with the request 148 (e.g., a holdings parameter for portfolio m=1 in FIG. 2) and computing the type of performance parameter for the identified portfolio based on portfolio data 136, other parameters of the request 148 (e.g., a selected time and/or time period), and the schemes described herein.

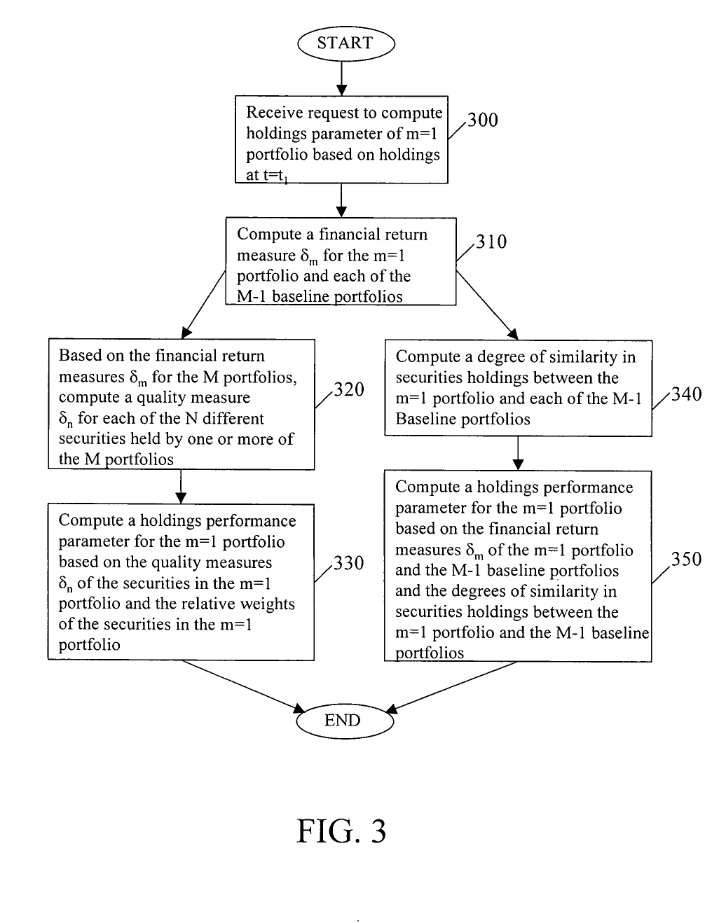

FIG. 3 schematically illustrates two embodiments of a method for computing a holdings parameter for a selected one of the M exemplary portfolios 200 shown in FIG. 2. In FIG. 3, a first embodiment is represented by flow elements 300, 310, 320, and 330, while a second embodiment is represented by flow elements 300, 310, 340, and 350. Features of the first and second embodiments are discussed below.

As shown in FIG. 3 for both the first and second embodiments, a request 148 for computing a holdings parameter of a selected one of the M exemplary portfolios based on the holdings of the portfolio at a selected time t can be received (300 in FIG. 3). For illustration, the selected portfolio is designated as the m=1 portfolio, the selected time is designated as t=t₁, and the remaining M-1 portfolios are designated as the baseline portfolios. As will be understood by those of ordinary skill in the art, the selected portfolio can include one or more of the M portfolios included in the portfolio data 136, and the baseline portfolios can include one or more of the remaining M-1 portfolios included in the portfolio data 136.

In both the first and second embodiments shown in FIG. 3, a financial return measure δₘ is computed for the m=1 portfolio and each of the M-1 baseline portfolios based on the financial return data 250 of the portfolios 200 (310 in FIG. 3). Generally, the financial return measure δₘ of a portfolio m represents an average financial return of the portfolio, such as, but not limited to, an average financial return of the portfolio in excess of a financial return on a benchmark. In some embodiments, the financial return measure δₘ for a portfolio m can be computed based on regressing financial returns of the portfolio m (i.e., the financial returns included in financial return data 250) in excess of a risk-free rate on a benchmark associated with an asset pricing model. For example, the financial return measure δₘ can include one of a Jensen's alpha, a Capital Asset Pricing Model alpha, a Fama-French alpha, and a four-factor or Carhart alpha, as these terms are understood by those of ordinary skill in the art. The financial return measure δₘ can include an estimator of one of the foregoing measures, such as a least squares estimator. (As will be understood by those of ordinary skill of the art, one or more of the disclosed measures, such as the financial return measure δₘ, the quality measure δₘ, and/or the performance parameters can include an estimator, such as a least squares estimator.) Alternatively, the financial return measure δₘ can include a measure representative of an average financial return of a portfolio known to those of ordinary skill in the art.

In the first embodiment shown in FIG. 3, based on the financial return measures δₘ for the M portfolios, a quality measure δₙ for each of the N different securities held by one or more of the M portfolios is computed (320 in FIG. 3). Generally, the quality measure δₙ of a security n represents the extent to which the security n is included in relatively successful portfolios (i.e., portfolios with relatively high financial return measures δₘ) and not included in relatively unsuccessful portfolios (i.e., portfolios with relatively low financial return measures δₘ). The quality measure δₙ can be computed based on an average of the financial return measures δₘ of the portfolios that include security n. In some embodiments, the quality measure δₙ for a security n can be computed based on a weighted average of the financial return measures δₘ of the portfolios that include security n, in which the weight of a financial return measure δₘ of a portfolio m is based on the quantity of security n included in the portfolio m. For example, in one such embodiment, the quality measure δₙ of a security n can be computed based on the weighted average
δₙ=Σₘw_{m,n}×δₘ, (1)
where w_{m,n} represents the relative weight of security n in portfolio m and the sum is over all portfolios m. For example, with reference to the portfolios of FIG. 2 at time t=t₁, security n=N-1 has a relative weight w_{1,N-1} of 100/(50+75+100+50)=0.36 in the m=1 portfolio, a relative weight w_{2,N-1} of 0 in the m=2 portfolio, and a relative weight w_{M,N-1} of 150/(25+75+150+10)=0.58 in the m=M portfolio. In some embodiments, the quality measure δₙ of a security n can be normalized based on the relative weights w_{m,n} of the security in all of the portfolios. For example, in one such embodiment, the quality measure δₙ of a security n can be computed based on the normalized sum
δₙ=Σₘ(1/Kₙ)×w_{m,n}×δₘ, (2)
where Kₙ is a normalization factor for security n that can be represented as
Kₙ=Eₘw_{m,n}, (3)
where the sum is over all portfolios m.

With continuing reference to the first embodiment shown in FIG. 3, a holdings parameter δₘ* can be computed for the m=1 portfolio based on the quality measures δₙ of the securities n included in the m=1 portfolio and the relative weights w_{m,n} of the securities included in the m=1 portfolio (330 in FIG. 3.) The holdings parameter δₘ* for a portfolio m can be computed based on an average of the quality measures δₙ of the securities included in the portfolio. In some embodiments, the holdings parameter δₘ* for a portfolio m can be computed based on the weighted average
δₘ*=Σₙw_{m,n}×δₙ, (4)
where the sum is over all securities n.

Generally, the holdings parameter δₘ* for a portfolio m represents the financial success of the portfolio m with respect to the M-1 baseline portfolios. A relatively high holdings parameter δₘ* can reflect a portfolio m that includes similar types and quantities of securities as relatively successful baseline portfolios (i.e., baseline portfolios having relatively high financial return measures δₘ), while a relatively low holdings parameter δₘ* can reflect a portfolio m that includes different types of and/or different quantities of similar types of securities as relatively successful baseline portfolios. The holdings parameter δₘ* can thus be used to assess the relative financial success of portfolios, such as mutual funds, based on relationships between the holdings of the portfolios at a time.

In the second embodiment of FIG. 3, a degree of similarity in securities holdings is computed between the m=1 portfolio and each of the M-1 baseline portfolios (340 in FIG. 3). The degree of similarity represents the extent to which the m=1 portfolio includes similar types and quantities of securities as the M-1 portfolios. In some embodiments, the degree of similarity z_{m,j} between a portfolio m and a portfolio j can be computed based on the relative weights of the securities included in the portfolios. For example, in one such embodiment, the degree of similarity z_{m,j} can be computed based on the sum
z_{m,j}=Σₙw_{m,n}×w_{j,n}, (5)
where the sum is over all securities n and w_{m,n} and w_{j,n} represent the relative weights of security n in portfolio m and portfolio j. In some embodiments, the degree of similarity z_{m,j} between portfolios m and j can be normalized based on the relative weights of the securities n in all of the portfolios. For example, in one such embodiment, the degree of similarity z_{m,j} can be computed based on the normalized sum
z_{m,j}=Σₙ(1/Kₙ)×w_{m,n}×w_{j,n}, (6)
where Kₙ is the normalization factor from equation 3.

With continuing reference to the second embodiment of FIG. 3, a holdings parameter δₘ* is computed for the m=1 portfolio based on the financial return measures δₘ of the m=1 portfolio and the M-1 baseline portfolios and the degrees of similarity z_{m,j} between the m=1 portfolio and the M-1 baseline portfolios. In some embodiments, the holdings parameter δₘ* for the m=1 portfolio can be computed based on a weighted average of the financial return measures δₘ of all portfolios, with the weights being the degrees of similarity z_{m,j} between the m=1 portfolio and all M portfolios. For example, in one such embodiment, the holdings parameter δₘ* can be computed based on the weighted average
δₘ*=Σⱼz_{m,j}×δⱼ, (7)
where the sum is over all portfolios j=1, 2, . . . , M and the weights z_{m,j} sum to one, i.e.,
Σⱼz_{m,j}=1. (8)

Two embodiments of the disclosed holdings parameter δₘ* are shown in equations 4 and 7. Both embodiments can be used to assess the relative financial success of a portfolio. In the embodiment of equation 4, the holdings parameter represents the extent to which a portfolio includes securities considered to be high quality by relatively financially successful portfolios. In the embodiment of equation 7, the holdings parameter represents the extent to which a portfolio includes similar types of securities as relatively financially successful portfolios and different types of securities as relatively financially unsuccessful portfolios.

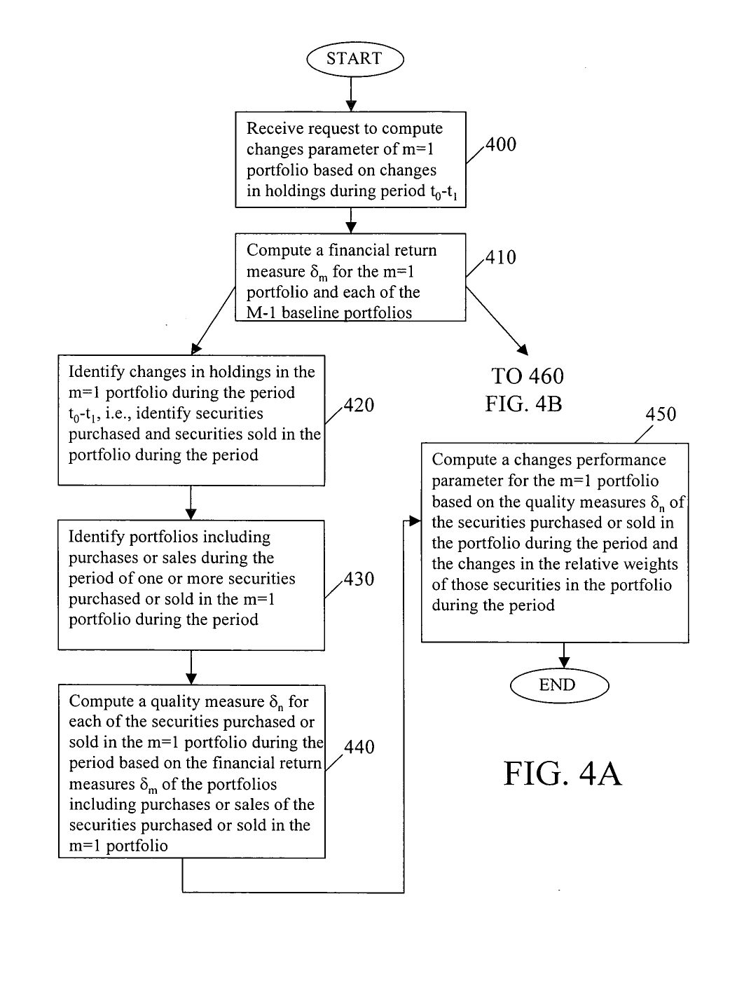

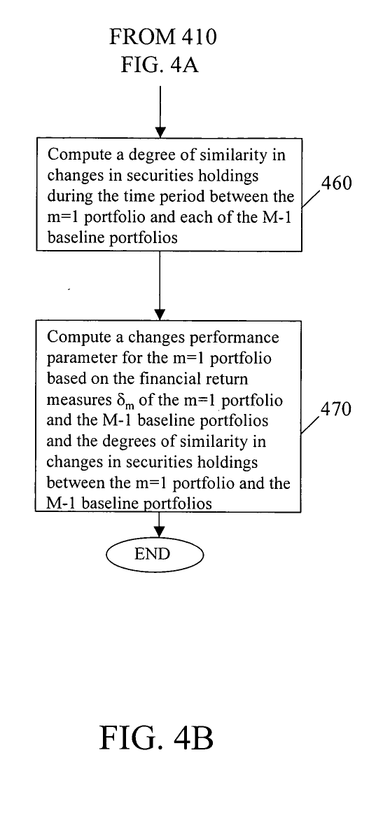

FIGS. 4A and 4B schematically illustrates two embodiments of a method for computing a changes parameter for a selected one of the M exemplary portfolios 200 shown in FIG. 2. In FIGS. 4A and 4B, a first embodiment is represented by flow elements 400, 410, 420, 430, 440, and 450, while a second embodiment is represented by flow elements 400, 410, 460, and 470. Features of the first and second embodiments are discussed below.

As shown in FIG. 4A for both the first and second embodiments, a request 148 for computing a changes parameter of a selected one of the M exemplary portfolios based on changes in holdings of the selected portfolio during a selected time period t′ can be received (400 in FIG. 4). For illustration, the selected portfolio is designated as the m=1 portfolio, the remaining M-1 portfolios are designated as the baseline portfolios, and the selected time period t′ is designed as the time period between time t₀ and time t₁.

In both the first and second embodiments shown in FIG. 4A, a financial return measure δₘ is computed for the m=1 portfolio and each of the M-1 baseline portfolios based on the financial return data 250 of the portfolios 200 (410 in FIG. 4A). The financial return measure δₘ can be computed based on the schemes previously described herein with respect to FIG. 3.

In the first embodiment shown in FIG. 4A, changes in holdings in the m=1 portfolio during the time period t′=t₀-t₁ are identified (420 in FIG. 4A). Generally, the changes in holdings in a portfolio can be determined based on comparing the holdings of the portfolio at time t₁ with the holdings of the portfolio at time t₀. Securities n that are purchased in a portfolio m during the time period (i.e., purchased on a net basis in the time period) are designated as elements of the set Nₘ⁺, and securities n that are sold in a portfolio m during the time period (i.e., sold on a net basis in the time period) are designated as elements of the set Nₘ⁻. Each of the sets Nₘ⁺ and Nₘ⁻ includes an integral number of members that can range from 0 to N.

Unless otherwise indicated, the terms purchase and sale as used herein refer to purchase and sale on a net basis between the beginning and ending times of a selected time period for computing the changes parameter (e.g., the beginning and ending times t₀ and t₁ of the time period t′). As such, for a time period t′ having a beginning time t₀ and an ending time t₁, a security is defined to be purchased in a portfolio m if there are greater holdings of the security in the portfolio m at the ending time t₁ than at the beginning time t₀, and defined to be sold in a portfolio m if there are smaller holdings of the security in the portfolio m at the ending time t₁ than at the beginning time t₀.

With continuing reference to the first embodiment shown in FIG. 4A, the one or more portfolios that made purchases or sales during the time period t′ of a security n that was purchased or sold in the m=1 portfolio during the same time period are identified (430 in FIG. 4A). These portfolios can be identified based on comparing the holdings in the portfolios at time t₁ with the holdings in the portfolios at time t₀. Portfolios m that made purchases of a security n during the time period t′ are designated as elements of the set Mₙ⁺, and portfolios m that made sales of a security n during the time period t′ are designated as elements of the set Mₙ⁻. Each of the sets Mₙ⁺ and Mₙ⁻ includes an integral number of members that can range from 0 to M.

In the first embodiment shown in FIG. 4A, based on the financial return measures δₘ for the Mₙ⁺ and Mₙ⁻ portfolios, a quality measure δₙ for each security n purchased or sold in the portfolio m=1 during the time period t′ is computed (i.e., δₙ is computed for each security n that is an element of either Nₘ₌₁⁺ or Nₘ₌₁⁻) (440 in FIG. 4A). Generally, the quality measure δₙ of a security n represents the extent to which the security n was purchased during the time period t′ by relatively successful portfolios (i.e., portfolios with relatively high financial return measures δₘ) and sold during the time period t′ by relatively unsuccessful portfolios (i.e., portfolios with relatively low financial return measures δₘ)

The quality measure δₙ of a security n can be computed based on a measure of the difference between a purchase component δₙ⁺ and a sales component δₙ⁻. In some embodiments, the quality measure δₙ can be computed based on a difference of these components. For example, in one such embodiment, the quality measure δₙ can be computed based on the difference
δₙ=δₙ⁺−δₙ⁻. (9)
Alternatively, in some embodiments, the quality measure δₙ can be computed from the purchase and sales components δₙ⁺ and δₙ⁻ based on a difference of squares, a square root of a difference of squares, and/or other difference measures known to those of ordinary skill in the art.

Generally, the purchase component δₙ⁺ is an average of the financial return measures δₘ of the Mₙ⁺ portfolios that made purchases of a security n during the time period t′, and the sales component δₙ⁻ is an average of the financial return measures δₘ of the Mₙ⁻ portfolios that made sales of the security n during the same time period. In some embodiments, the purchase component δₙ⁺ can be computed based on the weighted average
δₙ⁺=Σ_{mεM+}y_{m,n}⁺×δₘ, (10)
where the sum is over all portfolios m that are elements of the set Mₙ⁺ and where y_{m,n}⁺ represents the fraction of all purchases of security n during the time period t′ in the Mₙ⁺ portfolios that are accounted for by portfolio m (i.e., of all of the purchases of security n that were made by the Mₙ⁺ portfolios during the time period t′, the fraction that were made by portfolio m is y_{m,n}⁺). Similarly, in some embodiments, the sales component δₙ⁻ can be computed based on the weighted average
δₙ⁻=Σ_{mεM-}y_{m,n}⁻×δₘ, (11)
where the sum is over all portfolios m that are elements of the set Mₙ⁻ and where y_{m,n}⁻ represents the fraction of all sales of security n during the time period t′ in the Mₙ⁻ portfolios that are accounted for by portfolio m. The fractions y_{m,n}⁺ and y_{m,n}⁻ for a security n in a portfolio m can be computed based on the changes in the relative weights of the security n in the portfolio m during the time period t′. For example, with reference to FIG. 2, 50 units of security n=N were purchased in portfolio m=1 during the time period t′, 50 units of security n=N were sold in portfolio m=2 during the time period t′, and 40 units of security n=N were sold in portfolio m=M during the time period t′. As such, 50 total units of security n=N were purchased in the portfolios during the time period, and 90 units of security n=N were sold in the portfolios during the time period. Accordingly, the fraction y_{m,N}⁺ equals one for m=1 and zero for m=2 and m=M, and the fraction y_{m,N}⁻ equals zero for m=1, 50/90 for m=2, and 40/90 for m=3.

In some embodiments, the changes in the relative weights y_{m,n}⁺ and y_{m,n}⁻ can be normalized. For example, in one such embodiment, the fractions y_{m,n}⁺ and y_{m,n}⁻ can be represented as
y_{m,n}⁺=d_{m,n}×(1/K_{y+}) and y_{m,n}⁻=d_{m,n}×(1/K_{y-}) (12)
where d_{m,n} is the change in the relative weight of a security n in a portfolio m during the time period t′ and K_{y+} and K_{y-} are the normalization factors
K_{y+}=Σ_{mεM+}d_{m,n} and K_{y-}=Σ_{mεM-}d_{m,n}, (13)
where the sums are over all portfolios m that are elements of the sets Mₙ⁺ and Mₙ⁻, respectively. The change in relative weights d_{m,n} during a time period t′=t₁-t₀ can be computed based on the difference
d_{m,n}=w_{m,n}(t=t₁)−w_{m,n}(t=t₀)×(1+r_{n,t1})/(1+R_{m,t1}) (14)
where w_{m,n} is the relative weight of security n in portfolio m, r_{n,t1} is the financial return on security n at time t₁ and R_{m,t1} is the financial return of portfolio m at time t₁. The financial return of portfolio m at time t can be computed based on the sum
R_{m,t}=Σₙr_{n,t}, (15)
where the sum is over all securities n included in portfolio m at time t. The financial return r_{n,t} of a security n at a time t refers to the financial return of the security at the time t with respect to an earlier time. For example, the financial return r_{n,t1} refers to the financial return of security n at time t₁ with respect to time to and can include, for example, a per-cent change-in-value of security n during the time period t₀ to t₁, with such example being provided for illustration and not limitation. The financial return r_{n,t} of a security n at a time t can be computed based on schemes known to those of ordinary skill in the art.

With continuing reference to the first embodiment shown in FIG. 4A, a changes parameter δₘ** can be computed for the m=1 portfolio based on the quality measures δₙ of the Nₘ⁺ securities purchased and the Nₘ⁻ securities sold in the m=1 portfolio during the time period t′ and the changes in the relative weights of the Nₘ⁺ and Nₘ⁻ securities in the m=1 portfolio during the time period t′ (450 in FIG. 4A). Generally, the changes parameter δₘ** for a portfolio m represents a measure of the difference between an average of the quality measures of securities purchased (represented by δₘ⁺) and an average of the quality measures of securities sold (represented by δₘ⁻)in the portfolio m during the time period t′. In some embodiments, the changes parameter δₘ** can be computed based on a measure of the difference between purchase and sale components δₘ⁺ and δₘ⁻. For example, in one such embodiment, the changes performance parameter δₘ** can be computed based on the difference
δₘ**=δₘ⁺−δₘ⁻. (16)
Alternatively, in some embodiments, the changes performance parameter δₘ** can be computed from the purchase and sales components δₘ⁺ and δₘ⁻ based on a difference of squares, a square root of a difference of squares, and/or other difference measures known to those of ordinary skill in the art.

Generally, the purchase component δₘ⁺ is an average of the quality measures δₙ of the Nₘ⁺ securities purchased during the time period t′, and the sales component δₘ⁻ is an average of the quality measures of the and Nₘ⁻ securities sold during the same time period. In some embodiments, the purchase component δm⁺ can be computed based on the weighted average
δₘ⁺=Σ_{nεN+}x_{m,n}⁺×δₙ, (17)
where the sum is over all securities n that are elements of the set Nₘ⁺, and where x_{m,n}⁺ represents the fraction of all purchases of the Nₘ⁺ securities during the time period t′ in the portfolio m that are accounted for by security n (i.e., of all of the purchases of the Nₘ⁺ securities that were made in the m portfolio during the time period t′, the fraction that were purchases of security n is x_{m,n}⁺). Similarly, in some embodiments, the sales component δₘ⁻ can be computed based on the weighted average
δₘ⁻=Σ_{nεN-}x_{m,n}⁻33 δₙ, (18)
where the sum is over all securities n that are elements of the set Nₘ⁻ and where x_{m,n}⁻ represents the fraction of all sales of the Nₘ⁻ securities during the time period t′ in the portfolio m that are accounted for by security n. The fractions x_{m,n}⁺ and x_{m,n}⁻ for a security n in a portfolio m can be computed based on the changes in the relative weights of the security n in the portfolio m during the time period t′. In some embodiments, the changes in the relative weights can be normalized, so that the changes performance parameter can be computed based on relative changes in the relative weights. For example, in one such embodiment, the fractions x_{m,n}⁺ and x_{m,n}⁻ can be represented as
x_{m,n}⁺=d_{m,n}×(1/Kₓ₊) and x_{m,n}⁻=d_{m,n}×(1/Kₓ₋) (19)
where d_{m,n} is the change in the relative weight of a security n in a portfolio m during the time period t′ (computed, for example, based on equation 14) and Kₓ₊ and Kₓ₋ are the normalization factors
Kₓ₊=Σ_{nεN+}d_{m,n} and Kₓ₋=Σ_{nεN-}d_{m,n}, (20)
where the sums are over all securities n that are elements of the sets Nₘ⁺ and Nₘ⁻, respectively.

As previously described, in some embodiments, the changes parameter δₘ** for a portfolio m can be computed based on relative, i.e., normalized, changes in the relative weights of the securities n included in the portfolio m during the time period t′. Alternatively, in some embodiments, the changes parameter δₘ** for a portfolio m can be computed based on the absolute, i.e., non-normalized, changes in the relative weights of the securities n included in the portfolio m during the time period t′. In one such embodiment, the changes performance parameter δₘ** for a portfolio m can be computed based on the sum
δₘ**=Σₙd_{m,n}×δₙ, (21)
where the sum is over all securities n=1, 2, . . . , N included in the portfolio m at one or more times, d_{m,n} is the change in relative weights (computed, for example, based on equation 14), and δₙ is the quality measure of a security n (computed, for example, based on equations 9-11).

Generally, the changes performance parameter δₘ** for a portfolio m represents the financial success of the portfolio m with respect to the M-1 baseline portfolios. A relatively high changes performance parameter δₘ** tends to reflect a portfolio m that includes similar trades during a time period as relatively successful baseline portfolios (i.e., baseline portfolios having relatively high financial return measures δₘ), while a relatively low changes parameter δₘ** tends to reflect a portfolio m that includes different trades during a time period as relatively successful baseline portfolios. The changes parameter δₘ** can thus be used to assess the relative financial success of portfolios, such as mutual funds, based on relationships between changes in the holdings of the portfolios during a time period.

In the second embodiment shown FIG. 4B, a degree of similarity in changes in securities holdings during the time period t′ is computed between the m=1 portfolio and each of the M-1 baseline portfolios (460 in FIG. 4B). The degree of similarity in changes in securities holdings represents the extent to which the m=1 portfolio includes similar trades during the time period t′ as the M-1 portfolios. In some embodiments, the degree of similarity c_{m,j} in changes in securities holdings between a portfolio m and a portfolio j can be computed based on the changes in the relative weights of the securities n included in the portfolios. For example, in one such embodiment, the degree of similarity c_{m,j} can be computed based on the sum
c_{m,j}=Σₙ{x_{m,n}⁺y_{j,n}⁺1_{{nεN+}}1_{{jεM+}}−x_{m,n}⁺y_{j,n}⁻1_{{nεN+}}1_{{jεM-}} . . . −x_{m,n}⁻y_{j,n}⁺1_{{nεN-}}1_{{jεM+}}30 x_{m,n}⁻y_{j,n}⁻1_{{nεN-}}1_{{jεN-}}} (22)
where the sum is over all securities n and the symbol 1_{{}} denotes an indicator function equal to one based on the associated condition being true or zero based on the associated condition not being true.

With continuing reference to the second embodiment of FIG. 4B, a changes parameter δₘ** is computed for the m=1 portfolio based on the financial return measures δₘ of the m=1 portfolio and the M-1 baseline portfolios and the degrees of similarity c_{m,j} between the m=1 portfolio and the M-1 baseline portfolios (470 in FIG. 4B). In some embodiments, the changes parameter δₘ** for the m=1 portfolio can be computed based on a pseudo-weighted average of the financial return measures δₘ of all M portfolios, with the weights being the degrees of similarity c_{m,j} between the m=1 portfolio and all M portfolios. For example, in one such embodiment, the changes performance parameter δₘ** can be computed based on the pseudo-weighted average
δₘ*=Σⱼc_{m,j}×δⱼ, (23)
where the sum is over all portfolios j=1, 2, . . . , M. Since the weights c_{m,j} sum to zero rather than one, i.e., since
Σⱼc_{m,j}=0 (24)
for j=1, 2, . . . , M, the average in equation 23 is referred to as a pseudo-weighted average, rather than a weighted average.

Two embodiments of the disclosed changes parameter δₘ** are shown in equations 16 and 23. Both embodiments can be used to assess the relative financial success of a portfolio. In the embodiment of equation 16, the changes parameter represents the extent to which a portfolio includes purchases of securities considered to be high quality and sales of securities considered to be low quality by relatively financially successful portfolios (i.e., portfolios having relatively high financial return measures δₘ). In the embodiment of equation 23, the changes parameter represents the extent to which a portfolio includes similar trades as relatively financially successful portfolios and different trades as relatively financially unsuccessful portfolios (i.e., portfolios having relatively low financial return measures δₘ).

The disclosed holdings and changes parameters δₘ* and δₘ** can be computed iteratively for a selected portfolio. For example, in one such embodiment, the holdings parameter δₘ* of equation 4 can be computed for the m=1 portfolio and each of the M-1 baseline portfolios in FIG. 2. Using the computed holdings parameters δₘ* as the financial return measures δₘ in equation 2, the holdings parameter δₘ* of equation 4 can be re-computed for the m=1 portfolio. The changes parameter δₘ ** can be iteratively computed based on a similar scheme.

As previously described, the disclosed systems and methods compute holdings and changes-in-holdings performance-parameters for a portfolio based on relationships between the holdings of the portfolio and the holdings of one or more other portfolios at one or more times. The computed performance parameters can thus be used to determine the relative financial success of one or more portfolios. Other uses of the computed performance parameters include ranking portfolios and their managers based on relative financial success and developing one or more investment strategies based on such rankings. Further uses of the computed performance parameters will be apparent to those of ordinary skill in the art.

In some embodiments, the disclosed holdings and changes-in-holdings performance-parameters can be shown to have improved reliability compared to other performance parameters, such as those performance parameters that do not consider relationships between the holdings of different portfolios, e.g., Jensen's alpha and Sharpe's ratio. Features relating to the precision of the disclosed performance parameters are provided in U.S. Patent Application Ser. No. 60/443,445, the contents of which application are expressly incorporated by reference herein in their entirety.

The systems and methods described herein are not limited to a hardware or software configuration; they can find applicability in many computing or processing environments. The systems and methods can be implemented in hardware or software, or in a combination of hardware and software. The systems and methods can be implemented in one or more computer programs, in which a computer program can be understood to comprise one or more processor-executable instructions. The computer programs can execute on one or more programmable processors, and can be stored on one or more storage media readable by the processor, comprising volatile and non-volatile memory and/or storage elements.

The computer programs can be implemented in high level procedural or object oriented programming language to communicate with a computer system. The computer programs can also be implemented in assembly or machine language. The language can be compiled or interpreted. The computer programs can be stored on a storage medium or a device (e.g., compact disk (CD), digital video disk (DVD), magnetic disk, internal hard drive, external hard drive, random access memory (RAM), redundant array of independent disks (RAID), or removable memory device) that is readable by a general or special purpose programmable computer for configuring and operating the computer when the storage medium or device is read by the computer to perform the methods described herein.

Unless otherwise provided, references herein to memory can include one or more processor-readable and accessible memory elements and/or components that can be internal to a processor-controlled device, external to a processor-controlled device, and/or can be accessed via a wired or wireless network using one or more communications protocols, and, unless otherwise provided, can be arranged to include one or more external and/or one or more internal memory devices, where such memory can be contiguous and/or partitioned based on the application.

Unless otherwise provided, references herein to a/the processor and a/the microprocessor can be understood to include one or more processors that can communicate in stand-alone and/or distributed environment(s) and can be configured to communicate via wired and/or wireless communications with one or more other processors, where such one or more processor can be configured to operate on one or more processor-controlled devices that can include similar or different devices. Use of such processor and microprocessor terminology can be understood to include a central processing unit, an arithmetic logic unit, an application-specific integrated circuit, and/or a task engine, with such examples provided for illustration and not limitation.

Unless otherwise provided, use of the articles “a” or “an” herein to modify a noun can be understood to include one or more than one of the modified noun.

While the systems and methods described herein have been shown and described with reference to the illustrated embodiments, those of ordinary skill in the art will recognize or be able to ascertain many equivalents to the embodiments described herein by using no more than routine experimentation. Such equivalents are encompassed by the scope of the present disclosure and the appended claims. Accordingly, the systems and methods described herein are not to be limited to the embodiments described herein, can include practices other than those described, and are to be interpreted as broadly as allowed under prevailing law.

1. A method for computing a performance parameter of a first portfolio including one or more securities, the method comprising:
providing one or more baseline portfolios each including one or more securities,
for each of the portfolios, computing a financial return measure based on financial returns of the portfolio,
for each different security included in one or more of the portfolios, computing a quality measure based on the relative weights of the security in the portfolios and the financial return measures for the portfolios, and
computing the performance parameter for the first portfolio based on
the one or more quality measures, and
the relative weights
of the one or more securities included in the first portfolio.

2. The method of claim 1, wherein computing the financial return measure for a portfolio includes:
computing the financial return measure for the portfolio based on regressing financial returns for the portfolio in excess of a risk-free rate on a benchmark associated with an asset pricing model.

3. The method of claim 1, wherein the financial return measure includes one of: a Jensen's alpha, a Capital Asset Pricing Model alpha, a Fama-French alpha, and a four-factor alpha.

4. The method of claim 1, wherein computing the quality measure for a security further includes:
computing the quality measure for a security based on, for each portfolio that includes the security, the product of the financial return measure for the portfolio and the relative weight of the security in the portfolio.

5. The method of claim 4, wherein computing the quality measure for the security further includes:
computing the quality measure for the security based on a sum of the one or more products, and
normalizing the quality measure for the security based on a sum of the relative weights of the security in the portfolios.

6. The method of claim 1, wherein computing the performance parameter for the first portfolio includes:
computing the performance parameter for the first portfolio based on, for each security included in the first portfolio, the product of the quality measure for the security and the relative weight of the security in the portfolio.

7. The method of claim 6, wherein computing the performance parameter for the first portfolio includes:
computing the performance parameter for the first portfolio based on a sum of the one or more products.

8. The method of claim 1, wherein the securities include one or more of: a bond, a currency, a commodity, a futures contract, an option contract, and a stock.

9. The method of claim 1, wherein the portfolios are mutual funds.

10. The method of claim 1, further comprising:
iteratively computing the performance parameter for the first portfolio.

11. The method of claim 10, wherein iteratively computing the performance parameter for the first portfolio includes:
for each of the one or more baseline portfolios, computing a performance parameter,
for each portfolio, using the computed performance parameter as the financial return measure, and
re-computing the performance parameter for the first portfolio.

12. A method for computing a performance parameter of a first portfolio including one or more securities, the method comprising:
providing one or more baseline portfolios each including one or more securities,
for each of the portfolios, computing a financial return measure based on financial returns of the portfolio, and
computing the performance parameter for the first portfolio based on
the financial return measures of the portfolios, and
for each of the one or more baseline portfolios, the degree of similarity in securities holdings between the first portfolio and the baseline portfolio.

13. The method of claim 12, wherein computing the performance parameter for the first portfolio includes:
computing the performance parameter for the first portfolio based on a weighted average of the financial return measures of the first portfolio and the one or more baseline portfolios, where the weight of a financial return measure of a portfolio in the weighted average is based on a degree of similarity in securities holdings between the portfolio and the first portfolio.

14. The method of claim 13, wherein the degree of similarity in securities holdings between a portfolio and the first portfolio is based on, for each security included in one or more of the portfolio and the first portfolio, a product of the relative weight of the security in the portfolio and the relative weight of the security in the first portfolio.

15. The method of claim 14, wherein the degree of similarity in securities holdings between the portfolio and the first portfolio is based on a sum of the one or more products.

16. The method of claim 15, wherein the product is normalized based on a sum of the relative weights of the security in each of the portfolios.

17. The method of claim 12, wherein the securities include one or more of: a bond, a currency, a commodity, a futures contract, an option contract, and a stock.

18. The method of claim 12, wherein the portfolios are mutual funds.

19. The method of claim 12, further comprising:
iteratively computing the performance parameter for the first portfolio.

20. The method of claim 19, wherein iteratively computing the performance parameter for the first portfolio includes:
for each of the one or more baseline portfolios, computing a performance parameter,
for each portfolio, using the computed performance parameter as the financial return measure, and
re-computing the performance parameter for the first portfolio.

21. A processor program for computing a performance parameter of a first portfolio including one or more securities, the processor program being stored on a processor-readable medium and including instructions to cause a processor to:
receive data based on the first portfolio and the one or more first securities included in the first portfolio,
receive data based on one or more baseline portfolios and one or more securities included in the one or more baseline portfolios,
for each of the portfolios, compute a financial return measure based on financial returns of the portfolio,
for each different security included in one or more of the portfolios, compute a quality measure based on the relative weights of the security in the portfolios and the financial return measures for the portfolios, and
compute the performance parameter for the first portfolio based on
the one or more quality measures, and
the relative weights
of the one or more securities included in the first portfolio.

22. The processor program of claim 21, wherein the instructions to compute the financial return measure for a portfolio include instructions to:
compute the financial return measure for the portfolio based on regressing financial returns for the portfolio in excess of a risk-free rate on a benchmark associated with an asset pricing model.

23. The processor program of claim 21, wherein the instructions to compute the quality measure for a security include instructions to:
compute the quality measure for a security based on, for each portfolio that includes the security, the product of the financial return measure for the portfolio and the relative weight of the security in the portfolio.

24. The processor program of claim 21, wherein the instructions to compute the performance parameter include instructions to:
compute the performance parameter for the first portfolio based on, for each security included in the first portfolio, the product of the quality measure for the security and the relative weight of the security in the portfolio.

25. A method of computing a performance parameter of a first portfolio including one or more securities, the method comprising:
providing one or more baseline portfolios each including one or more securities,
for each of the portfolios, computing a financial return measure based on one or more financial returns of the portfolio,
for each security purchased or sold in the first portfolio during a time period, computing a quality measure based on:
the fraction of all purchases of the security during the time period in the portfolios accounted for by each portfolio,
the fraction of all sales of the security during the time period in the portfolios accounted for by each portfolio, and
the financial return measure of each portfolio, and
computing the performance parameter for the first portfolio based on:
the one or more quality measures, and
the changes in the relative weights
for each security purchased or sold in the first portfolio during the time period.

26. The method of claim 25, wherein computing the financial return measure for a portfolio includes:
computing the financial return measure for the portfolio based on regressing financial returns for the portfolio in excess of a risk-free rate on a benchmark associated with an asset pricing model.

27. The method of claim 25, wherein the financial return measure includes one of: a Jensen's alpha, a Capital Asset Pricing Model alpha, a Fama-French alpha, and a four-factor alpha.

28. The method of claim 25, wherein computing the quality measure for a security further includes:
computing the quality measure for a security based on:
for each portfolio including a purchase of the security during the time period, a first product of the fraction of all purchases of the security during the time period in the portfolios accounted for by the portfolio and the financial return measure of the portfolio, and
for each portfolio including a sale of the security during the time period, a second product of the fraction of all sales of the security during the time period in the portfolios accounted for by the portfolio and the financial return measure of the portfolio.

29. The method of claim 28, wherein computing the quality measure for the security further includes:
computing the quality measure based on a first sum of the one or more first products and a second sum of the one or more second products.

30. The method of claim 29, wherein computing the quality measure for the security further includes:
computing the quality measure for the security based on a difference measure of the first sum and the second sum.

31. The method of claim 30, wherein the difference measure includes one of: a difference, a difference of squares, and a square root of a difference of squares.

32. The method of claim 25, wherein computing the performance parameter for the first portfolio includes:
computing the performance parameter for the first portfolio based on
for each security purchased in the first portfolio, a first product of the fraction of all purchases in the first portfolio accounted for by the security and the quality measure of the security, and
for each security sold in the first portfolio, a second product of the fraction of all sales in the first portfolio accounted for by the security and the quality measure of the security.

33. The method of claim 32, wherein computing the performance parameter for the first portfolio further includes:
computing the performance parameter based on a first sum of the one or more first products and a second sum of the one or more second products.

34. The method of claim 33, wherein computing the performance parameter for the first portfolio further includes:
computing the performance parameter for the first portfolio based on a difference measure of the first sum and the second sum.

35. The method of claim 34, wherein the difference measure includes one of: a difference, a difference of squares, and a square root of a difference of squares.

36. The method of claim 25, wherein the securities include one or more of: a commodity, a futures contract, an option contract, and a stock.

37. The method of claim 25, wherein the portfolios are mutual funds.

38. The method of claim 25, further comprising:
iteratively computing the performance parameter for the first portfolio.

39. The method of claim 38, wherein iteratively computing the performance parameter for the first portfolio includes:
for each of the one or more baseline portfolios, computing a performance parameter,
for each portfolio, using the computed performance parameter as the financial return measure, and
re-computing the performance parameter for the first portfolio.

40. A method of computing a performance parameter of a first portfolio including one or more securities, the method comprising:
providing one or more baseline portfolios each including one or more securities,
for each of the portfolios, computing a financial return measure based on one or more financial returns of the portfolio, and
computing the performance parameter for the first portfolio based on:
the financial return measures for each of the portfolios, and
for each of the one or more baseline portfolios, the degree of similarity in changes in securities holdings during a time period between the first portfolio and the baseline portfolio.

41. The method of claim 40, wherein computing the performance parameter for the first portfolio includes:
computing the performance parameter for the first portfolio based on a pseudo-weighted average of the financial return measures of the first portfolio and the one or more baseline portfolios, where the weight of a financial return measure of a portfolio in the pseudo-weighted average is based on a degree of similarity in changes in securities holdings during the time period between the portfolio and the first portfolio, and where the sum of the weights in the pseudo-weighted average is zero.

42. The method of claim 41, wherein the degree of similarity in changes in securities holdings between a portfolio and the first portfolio is based on:
for each security purchased in both portfolios during the time period, a first product of the fraction of all purchases of the security in the portfolios accounted for by the portfolio and the fraction of all purchases in the first portfolio accounted for by the security,
for each security sold in both portfolios during the time period, a second product of the fraction of all sales of the security in the portfolios accounted for by the portfolio and the fraction of all sales in the first portfolio accounted for by the security,
for each security sold in the portfolio and purchased in the first portfolio during the time period, a third product of the fraction of all sales of the security in the portfolios accounted for by the portfolio and the fraction of all purchases in the first portfolio accounted for by the security, and
for each security purchased in the portfolio and sold in the first portfolio during the time period, a fourth product of the fraction of all purchases of the security in the portfolios accounted for by the portfolio and the fraction of all sales in the first portfolio accounted for by the security.

43. The method of claim 42, wherein the degree of similarity in changes in securities holdings between the portfolio and the first portfolio is based on:
a first sum of the first products, a second sum of the second products, a third sum of the third products, and a fourth sum of the fourth products.

44. The method of claim 43, wherein the degree of similarity in changes in securities holdings between a portfolio and the first portfolio is based on:
a fifth sum of the first sum and the second sum,
a sixth sum of the third sum and the fourth sum, and
a difference measure of the fifth sum and the sixth sum.

45. The method of claim 44, wherein the difference measure include one of: a difference, a difference of squares, and a square root of a difference of squares.

46. The method of claim 40, wherein the securities include one or more of: a commodity, a futures contract, an option contract, and a stock.

47. The method of claim 40, wherein the portfolios are mutual funds.

48. The method of claim 40, further comprising:
iteratively computing the performance parameter for the first portfolio.

49. The method of claim 48, wherein iteratively computing the performance parameter for the first portfolio includes:
for each of the one or more baseline portfolios, computing a performance parameter,
for each portfolio, using the computed performance parameter as the financial return measure, and
re-computing the performance parameter for the first portfolio.

50. A processor program for computing a performance parameter of a first portfolio including one or more securities, the processor program being stored on a processor-readable medium and including instructions to cause a processor to:
receive data based on the first portfolio and the one or more securities included in the first portfolio,
receive data based on one or more baseline portfolios and one or more securities included in the one or more baseline portfolios,
for each of the portfolios, compute a financial return measure based on one or more financial returns of the portfolio,
for each security purchased or sold in the first portfolio during a time period, compute a quality measure based on:
the fraction of all purchases of the security during the time period in the portfolios accounted for by each portfolio,
the fraction of all sales of the security during the time period in the portfolios accounted for by each portfolio, and
the financial return measure of each portfolio, and
compute the performance parameter for the first portfolio based on:
the one or more quality measures, and
the changes in the relative weights
for each security purchased or sold in the first portfolio during the time period.

51. The processor program of claim 50, wherein the instructions to compute the financial return measure for a portfolio include instructions to:
compute the financial return measure for the portfolio based on regressing financial returns for the portfolio in excess of a risk-free rate on a benchmark associated with an asset pricing model.

52. The processor program of claim 50, wherein the instructions to compute the quality measure for a security include instructions to:
compute the quality measure for a security based on:
for each portfolio including a purchase of the security during the time period, a first product of the fraction of all purchases of the security during the time period in the portfolios accounted for by the portfolio and the financial return measure of the portfolio, and
for each portfolio including a sale of the security during the time period, a second product of the fraction of all sales of the security during the time period in the portfolios accounted for by the portfolio and the financial return measure of the portfolio.

53. The processor program of claim 52, wherein the instructions to compute the performance parameter for the first portfolio include instructions to:
compute the performance parameter for the first portfolio based on
for each security purchased in the first portfolio, a first product of the fraction of all purchases in the first portfolio accounted for by the security and the quality measure of the security, and
for each security sold in the first portfolio, a second product of the fraction of all sales in the first portfolio accounted for by the security and the quality measure of the security.

54. A processor program for computing a performance parameter of a first portfolio including one or more securities, the processor program being stored on a processor-readable medium and including instructions to cause a processor to:
receive data based on the first portfolio and the one or more securities included in the first portfolio,
receive data based on one or more baseline portfolios and one or more securities included in the one or more baseline portfolios,
for each of the portfolios, computing a financial return measure based on one or more financial returns of the portfolio, and
computing the performance parameter for the first portfolio based on the financial return measures for each of the portfolios and at least one of:
for each of the one or more baseline portfolios, the degree of similarity in securities holdings between the first portfolio and the baseline portfolio, and
for each of the one or more baseline portfolios, the degree of similarity in changes in securities holdings during a time period between the first portfolio and the baseline portfolio.

55. The processor program of claim 54, wherein the instructions to compute the performance parameter based on the degree of similarity in securities holdings between the first portfolio and the baseline portfolio include instructions to:
compute the performance parameter for the first portfolio based on a weighted average of the financial return measures of the first portfolio and the one or more baseline portfolios, where the weight of a financial return measure of a portfolio in the weighted average is based on a degree of similarity in securities holdings between the portfolio and the first portfolio.

56. The processor program of claim 55, wherein the degree of similarity in securities holdings between a portfolio and the first portfolio is based on, for each security included in one or more of the portfolio and the first portfolio, a product of the relative weight of the security in the portfolio and the relative weight of the security in the first portfolio.

57. The processor program of claim 54, wherein the instructions to compute the performance parameter based on the degree of similarity in changes in securities holdings during a time period between the first portfolio and the baseline portfolio include instructions to:
compute the performance parameter for the first portfolio based on a pseudo-weighted average of the financial return measures of the first portfolio and the one or more baseline portfolios, where the weight of a financial return measure of a portfolio in the pseudo-weighted average is based on a degree of similarity in changes in securities holdings during the time period between the portfolio and the first portfolio, and where the sum of the weights in the pseudo-weighted average is zero.

58. The processor program of claim 57, wherein the degree of similarity in changes in securities holdings between a portfolio and the first portfolio is based on:
for each security purchased in both portfolios during the time period, a first product of the fraction of all purchases of the security in the portfolios accounted for by the portfolio and the fraction of all purchases in the first portfolio accounted for by the security,
for each security sold in both portfolios during the time period, a second product of the fraction of all sales of the security in the portfolios accounted for by the portfolio and the fraction of all sales in the first portfolio accounted for by the security,
for each security sold in the portfolio and purchased in the first portfolio during the time period, a third product of the fraction of all sales of the security in the portfolios accounted for by the portfolio and the fraction of all purchases in the first portfolio accounted for by the security, and
for each security purchased in the portfolio and sold in the first portfolio during the time period, a fourth product of the fraction of all purchases of the security in the portfolios accounted for by the portfolio and the fraction of all sales in the first portfolio accounted for by the security.
